(19) United States
(12) Patent Application Publication
(10) Pub. No.: US 2003/0158800 A1
(43) Pub. Date: Aug. 21, 2003

(54) Methods and apparatus for financial evaluation of information technology projects

(76) Inventors: Thomas Pisello, Winter Park, FL (US); Stephen Arseneault, Orlando, FL (US); Michael Friedlander, Chicago, IL (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/238,077

(22) Filed: Sep. 10, 2002

Related U.S. Application Data
(60) Provisional application No. 60/358,404, filed on Feb. 21, 2002.

(51) Int. Cl. G06F 17/60

(52) U.S. Cl. 705/35

(57) ABSTRACT

Apparatus and methods of evaluating an IT project within an organization is described herein. Evaluation of an IT project is undertaken by receiving a first set of data representative of financial information about the organization and future assumptions about the organization, receiving a second set of data representative of characteristics of the first IT project, and automatically generating a first set of indices based at least in part on the first and the second set of data.

### CROSS-REFERENCE TO RELATED APPLICATIONS

This application claims priority to U.S. Provisional Application Serial No. 60/358,404, entitled, “ValueIT®,” filed Feb. 1, 2002, the disclosure of which is hereby expressly incorporated herein by reference.

### TECHNICAL FIELD

The present patent relates generally to computer software, and more specifically, to methods and apparatus for financial evaluation of information technology projects.

### BACKGROUND ART

In the new information economy information technology (IT) investments have exceeded all other capital spending. IT investments in US peaked in 2000 to almost $1 trillion. In the 1990s companies made IT investments to reduce cost, to enhance productivity or to solve specific business challenges. However, many of the investments in the IT projects at many companies did not deliver the expected returns. With the change in the economic climate, chief information officers (CIO) are under a lot of pressure to justify the IT budget of the companies. Increasingly CIOs are required to measure the value of such IT projects and they are expected to achieve more with fewer resources than were available in the late 1990s. Such constraints make it very important for CIOs and other IT professionals to communicate the value of IT investments effectively to executive officers and other stakeholders in any organization.

It is difficult for CIOs to quantify the value of various IT projects to allow an objective comparison with other investments within an organization. Moreover, it is hard for CIOs to establish a clear connection between an IT project and the strategy of a business, or to link various technology initiatives to shareholder value. IT projects are generally more expensive then they first appear, and the value they deliver is more difficult to measure. Similarly, evaluating IT projects is fundamentally more complex because of the range and quantity of inherent hidden costs as well as the range and quantity of soft or intangible benefits of IT projects.

CFOs and other executive officers who may ultimately approve or decline investments in IT projects generally look for objective analysis and quantitative measures that they can compare to other projects in the organization. Measures such as economic value added (EVA), return on investments (ROI), internal rate of return (IRR), net present value (NPV), payback period, etc., make it easy for CFOs to objectively compare various projects against each other. On the other hand, generally CIOs and other IT executives are not familiar with such quantitative measures or the methods of calculating them. Moreover, even if they are familiar with such measures, they either do not know how to organize the data or they do not have the time to do such lengthy analysis. Several organizations use consultants to do such analysis, however, this solution is very expensive and very ad-hoc in that the solution is specific to one project and it is not adaptable to be used with other IT projects.

Even within IT departments there are usually a number of ongoing projects that are distinct from each other. For example, an organization could be working at any time on a project in sales force automation, e-commerce, disaster recovery management, etc. In such a situation there is a lot of information among these projects that is common between them and a lot that is particular to each individual projects. There is no system available that allows one to use ready-made templates that share information common to such projects even where each template is designed to analyze specific IT projects individually. Having such ready-made templates specific to project type will also help save considerable time and expenses of conducting individual analysis of each project separately.

Another problem facing the IT executives as well as CFOs in evaluating IT projects is lack of industry-wide benchmark that can be used to evaluate a given IT project. For a public company, as a result of market demands and as a result of shareholder requirements, CFOs, CEOs and the board of directors require that the company continually compare itself to peers. With IT being an increasingly important strategic tool, and with increasingly more significant investment and expenditure in IT projects, budgets of various IT projects need to be compared, individually and collectively for an organization, against peer spending and performance data. At least for these reasons, it is very important for an executive to compare the IT expenditure on various projects within an organization against IT expenditure of competitors and other companies in the industry.

Yet another problem facing the IT executives is difficulty in analyzing an IT project which is in progress against the initial goals of such an IT project. Since, there is no way to record several tangible and intangible benefits accrued to an organization due to implementation of an IT project, it is impossible to evaluate how successful an IT project has been. It will be very useful to be able to evaluate the progress of various IT projects using project specific templates that can be used to record various benefits. Lastly, before deciding to implement an IT project it is very important for an IT executive to compare various possible alternatives and the performance of each of these alternatives in various business situations. Such scenario analysis allows an IT executive to select the best possible IT project that is expected to optimally contribute scarce IT resources.

### BRIEF DESCRIPTION OF THE DRAWINGS

The present patent is illustrated by way of example and not limitation in the accompanying figures, in which like references indicate similar elements, and in which:

FIG. 1 is a block diagram of an example computer which may be used to execute an example program to evaluate an IT project;

FIG. 2 is a block diagram of an example apparatus to evaluate an IT project;

FIG. 3 is a flowchart illustrating an example program to evaluate an IT project;

FIG. 4 is a flowchart illustrating an example program to calculate the return on investment (ROI) of an IT project;

FIG. 5 is a flowchart illustrating an example program to compare IT spending of an organization with IT spending of other organizations;

FIG. 6 is a flowchart illustrating an example program to calculate the budget of an IT project;

FIG. 7 is a block diagram of a data network adapted to implement an apparatus to evaluate an IT project;

FIG. 8 is a block diagram of a network computer adapted to implement an apparatus to evaluate an IT project; and

FIG. 9 is a block diagram of a computing facility adapted to implement an apparatus to evaluate an IT project.

### DESCRIPTION OF THE PREFERRED EXAMPLES

Referring to a preferred example, the accompanying drawings illustrate a method and system of evaluating a first IT project within an organization. Such a method may comprise the steps of receiving a first set of data representative of financial information about the organization and future assumptions about the organization, receiving a second set of data representative of characteristics of the first IT project, and generating a first set of indices based at least in part on the first and the second set of data. The characteristics of the first IT project may include at least one of costs of the first IT project, investments required by the first IT project, savings generated by the first IT project and strategic benefits generated by the first IT project. Furthermore, the strategic benefits generated by the IT project may include a number of intangible benefits.

Referring to yet another preferred example, the accompanying drawings illustrate a method of evaluating a first IT project within a first organization comprising receiving a first set of data representative of financial information about the first organization and future assumptions about the first organization, receiving a second set of data representative of characteristics of the first IT project, receiving a third set of data representative of past financial information and past IT expenditure of a first group of organizations, generating a first set of indices based at least in part on the first and the second set of data, calculating a second set of indices based at least in part on the third set of data, and comparing at least one member of the first set of indices with a corresponding member of the second set of indices.

Referring to yet another preferred example, the accompanying drawings illustrate a project evaluation system for evaluating a first IT project within a first organization, where the system comprises a computer processor communicating with a data entry device configured to receive a first set of data representative of revenues, expenses, investments and strategic goals of the first organization, and a second set of data representative of costs, savings, strategic benefits and risks related to the first IT project, a memory, a processing unit, and a first software routine stored in the memory and adapted to be executed on the processing unit for calculating a first set of indices based at least in part on the first and the second set of data.

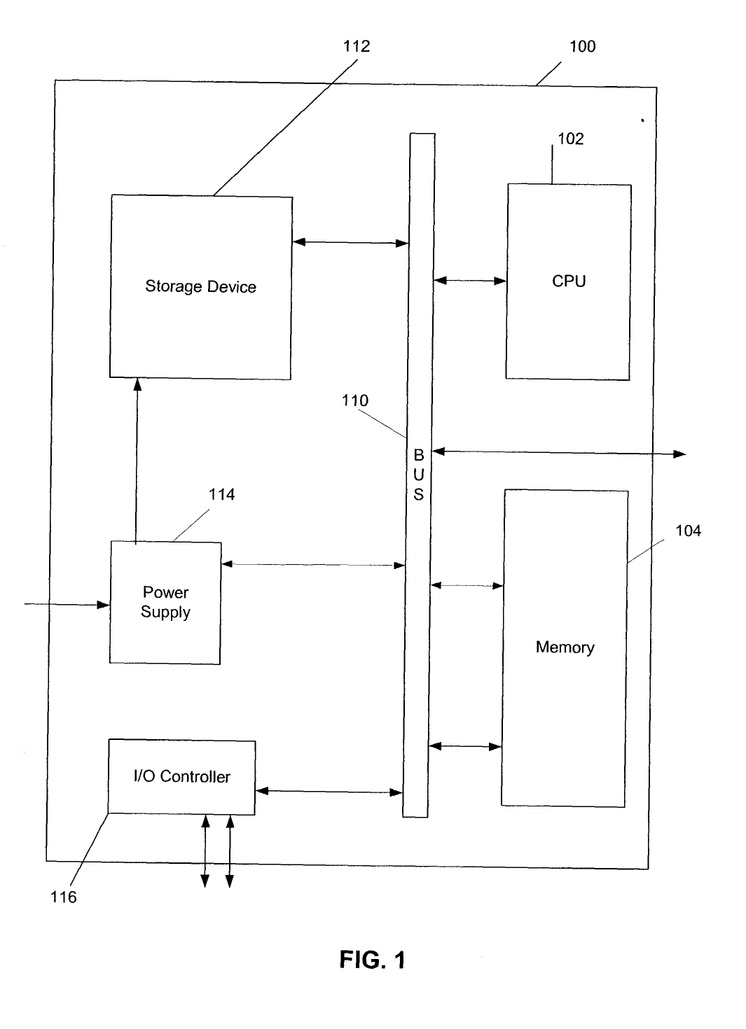

Referring now specifically to the accompanying drawings, FIG. 1 is a block diagram of an example computer 100. As used herein, the term “computer” refers to any computer (e.g. portable computer, laptop computer, PDA, desktop computer, server, etc.) that employs any type of software to manage exceptions. The computer 100 of the instant example contains many conventional hardware components commonly used in computers. For example, as shown in FIG. 1, the computer 100 includes a central processing unit (CPU) 102, a memory 104, a communications bus 110, a storage device 112, a power supply 114 and an input/output (I/O) controller 116. Even though the instant example of the computer 100 shows these components internal to the computer, a person of ordinary skill in the art will appreciate that some of these components can be external to the computer 100.

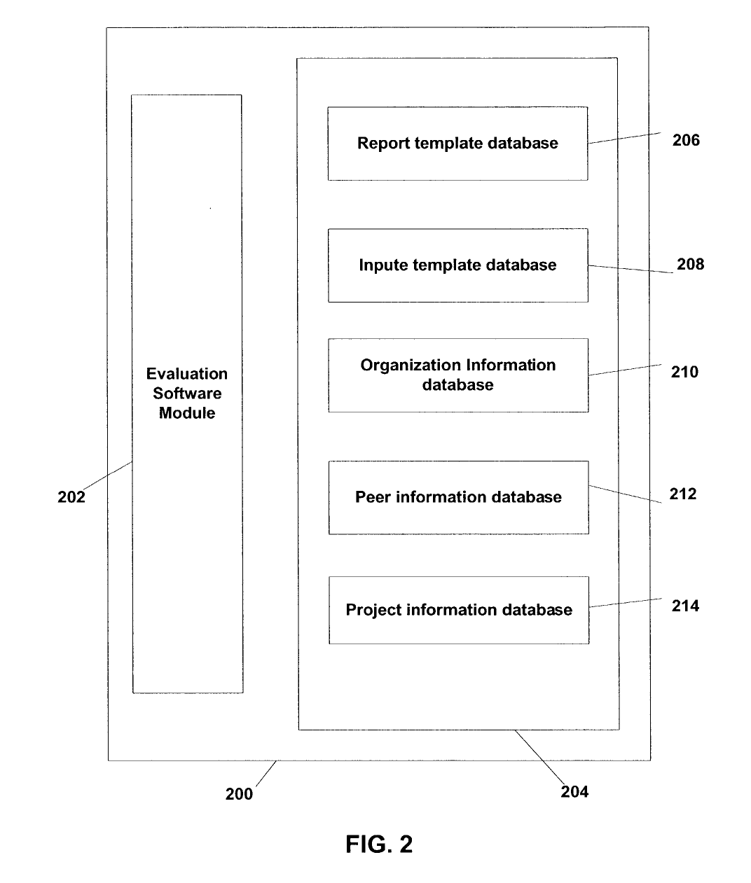

FIG. 2 is a block diagram of an example apparatus 200 to evaluate an IT project. The illustrated apparatus 200 includes an evaluation software module 202 and a database module 204 containing a number of databases 206-214. Such a database module 204 can be either stored on the computer memory 104 shown in FIG. 1 or it can be located on some external memory module such as a CD-ROM, etc. Such a database module 204 includes a report template database 206, an input template database 208, an organization information database 210, a peer information database 212 and a project information database 214.

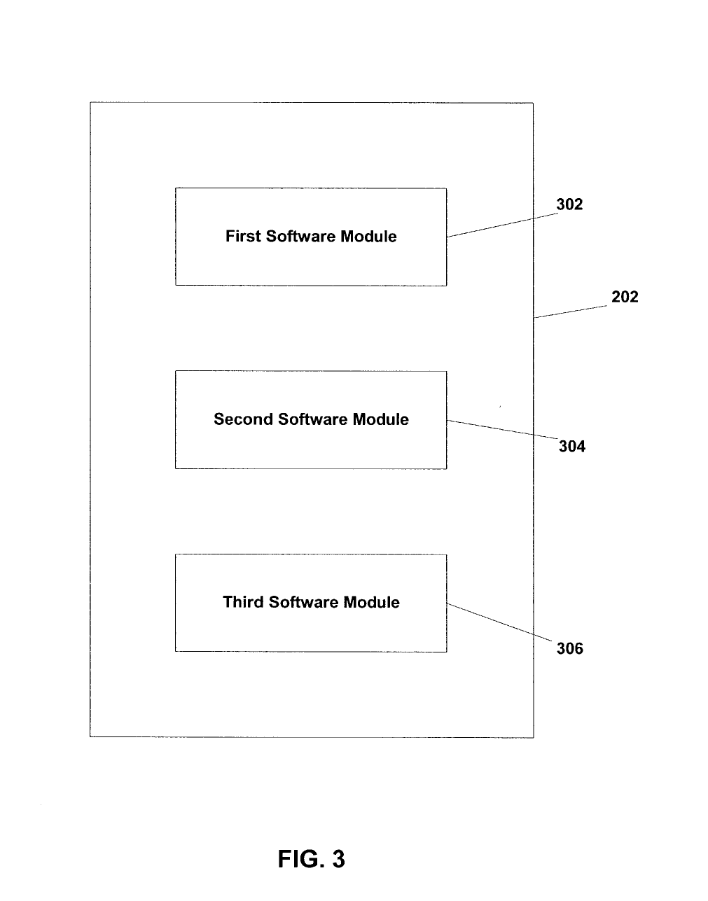

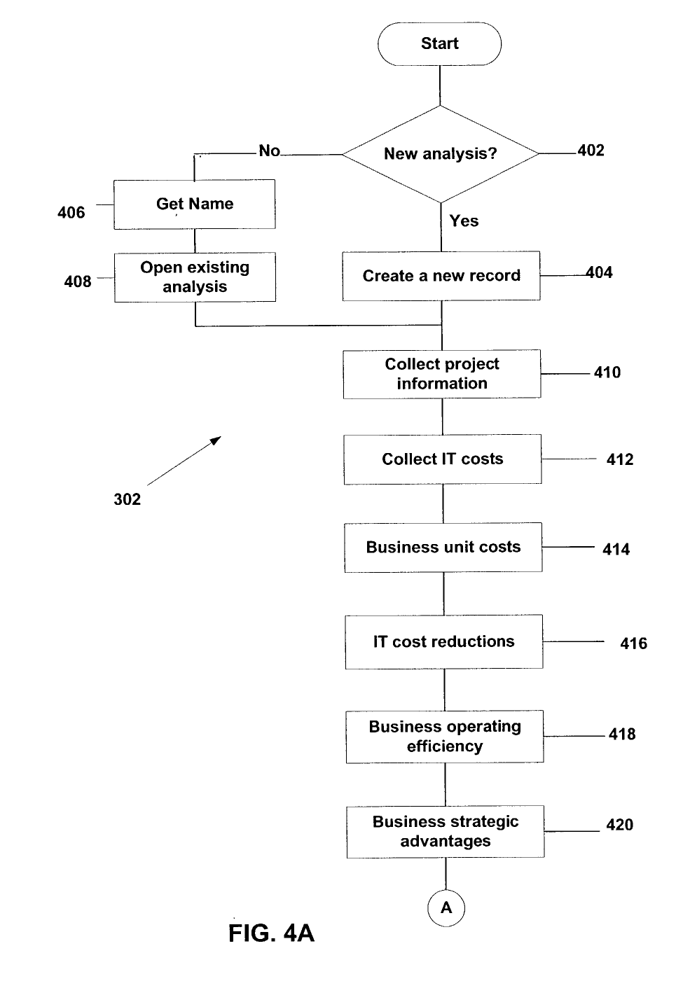

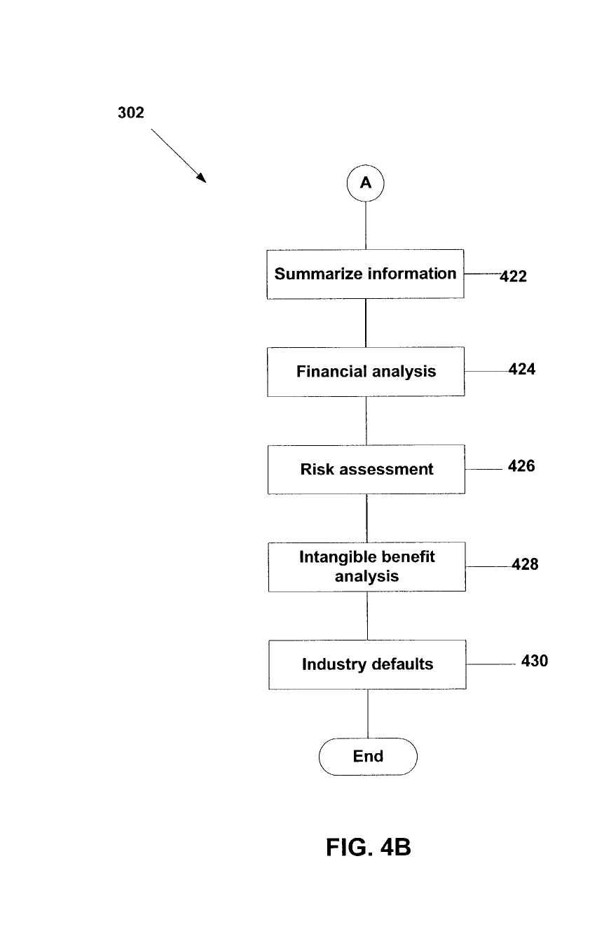

FIG. 3 is a block diagram of the evaluation software module 202. In this embodiment, the evaluation software module 202 contains a first software module 302, a second software module 304 and a third software module 306. The first software module 302 uses a number of input templates from the input template database 208 to collect data from a user. Using the input template database 208, the first software module 302 also collects information about an organization. First software module 302 saves such information regarding an organization in the organization information database 210. The first software module 302 also collects information about one or more IT projects to be undertaken by the organization using the input templates from the input template database 208. The first software module 302 saves such information regarding one or more IT projects in the project information database 214. The first software module 302 also performs a number of calculations to generate a number of indices using the data stored in the project information database 214 and the data stored in the organization information database 210. The first software module 302 also generates a number of reports based on the information from the project information database 214 and the information from the organization information database 210 using one or more report templates from the report template database 206. The functioning of the first software module 302 is described in more detail in FIG. 4.

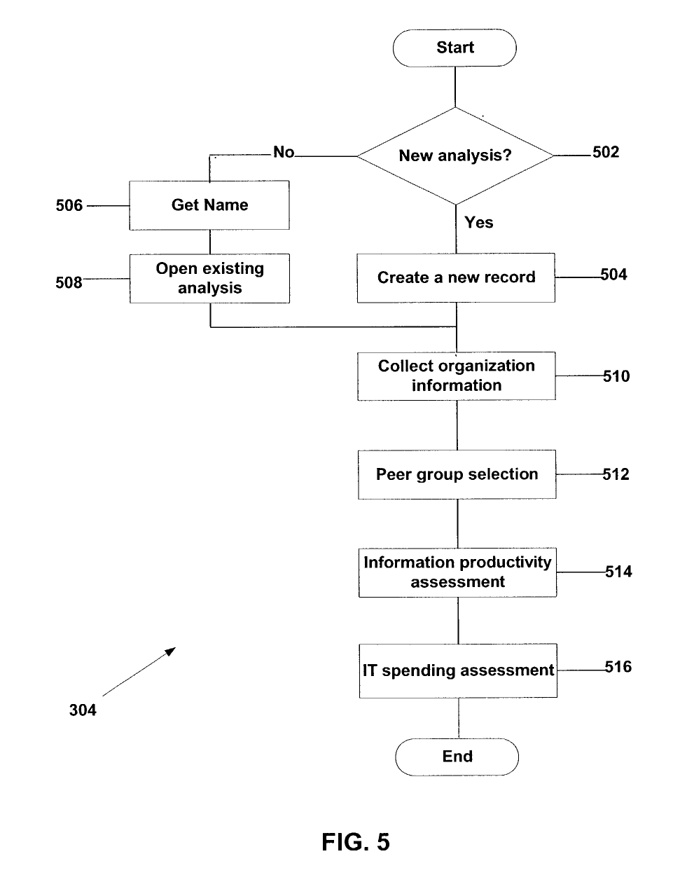

The second software module 304 uses a number of input template modules from the input template database 208 to collect data from a user. The second software module 304 collects information about an organization and about a list of other organizations to which the user wants to do any comparison. The second software module 304 saves such information regarding the organization in the organization information database 210. The second software module 304 also collects information about one or more peer organization using a number of input templates from the input template database 208. Alternatively, such information about peer organizations may also be provided in the form of a database on a CD-ROM or some other format. The second software module 304 saves such information regarding one or more peer organizations in the peer information database 212. The second software module 304 also performs a number of calculations to generate a number of indices using the data stored in the organization information database 210 and in the peer information database 212. The second software module 304 also generates a number of reports based on the information from the peer information database 212 and the organization information database 210 using one or more report templates from the report template database 206. The functioning of the second software module 304 is described in more detail in FIG. 5.

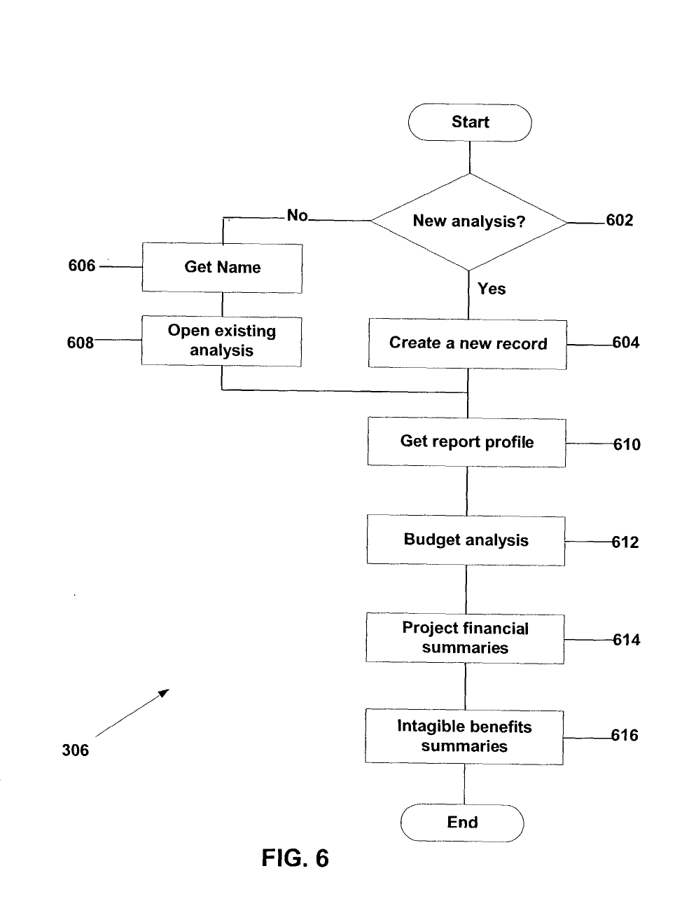

The third software module 306 uses a number of input templates from the input template database 208 to collect data from a user. Using the input templates from the input template database 208, the third software module 306 collects information about an organization for which a user wants to do any kind of IT budget analysis. The third software module 306 saves such information regarding the organization in the organization information database 210. Using input templates from the input template database 208 the third software module 306 also collects information about one or more IT projects to be undertaken by the organization. The third software module 306 saves such information regarding one or more IT projects in the project information database 214. The third software module 306 also performs a number of calculations to generate a number of indices using the data stored in the project information database 214 and the information stored in the organization information database 210. Using one or more report templates from the report template database 206, the third software module 306 also generates a number of reports based on the information from the project information database 214 and the organization information database 210. The functioning of the third software module 306 is described in more detail in FIG. 6.

Persons of ordinary skill in the art will readily appreciate that any or all of the first software module 302, the second software module 304, and/or the third software module 306 can be implemented by hardware, firmware and/or software. In the illustrated embodiment of the evaluation software module 202, each of these is implemented by software executing on the CPU 102.

FIGS. 4A and 4B shows a flowchart illustrating an example first software module 302 to calculate the return on investment (ROI) of an IT project. Although the first software module 302 is described with reference to the flowchart illustrated in FIGS. 4A and 4B, a person of ordinary skill in the art will readily appreciate that many other methods of performing the acts associated with first software module 302 may be used. For example, the order of many of the blocks may be changed, and some of the blocks described in here may be removed without affecting the performance of the other blocks within the first software module 302. The first software module 302 may reside in either the memory 104 of the computer illustrated in FIG. 1, or it may be stored on some other computer readable medium, such as a floppy disk, a compact disk, etc.

Referring to FIGS. 4A and 4B, at block 402, the first software module 302 presents an input template to a user asking whether the user wants to continue an existing project analysis using information stored in the memory 200 or start a new project analysis. If the user indicates to start a new project analysis, at block 404 the first software module 302 creates a new records in the organization information database 210 and the project information database 214. However, if the user indicates to continue an existing project analysis, at block 406, the first software module 302 asks the user to name the existing project analysis that the user wants to open. At block 408, the first software module 302 presents an input template from the input template database 208 to show information from the records in the project information database 214 and the organization information database 210, where such records are related to the project analysis named by the user at block 406. Once the user indicates whether he wants to work on a new project analysis or he wants to open an existing project analysis, the first software module 302 presents a series of input templates form the input template database 208. The only difference between the templates presented to the user when the user indicates to create a new project analysis versus when a user indicates to work on an existing project analysis is that when a new project analysis is selected, the subsequent input templates are not populated with any information, whereas when an existing project analysis is selected the subsequent input templates are populated with data from an organization record in the organization information database 210 or with data from a project record from a project information database 214. When a new project analysis is indicated, the user can input data in any of the subsequent templates presented by the first software module 302. Similarly, if an existing project analysis is indicated, the user can input or change data in any of the subsequent templates presented by the first software module 302. Because the input templates appearing during the execution of the first software module 302 are same for both a new project analysis or for an existing project analysis, the remainder of the presented by the first software module 302 is described with respect to creation of a new project analysis only. It should be understood that the same input templates can also be used to change data for an existing project analysis.

At block 410, the presented by the first software module 302 presents to the user a project information template from the input template database 208. The project information template asks the user to input key information about a project being analyzed. Such key information may include a project name, a short description of the project, start date for the project, a name of project manager, a main budgetary goal of the project, a main strategic goal of the project, etc. While some of this information is entered in a free form, i.e., the user can input any text in the project information template (for example, the name of a project manager is the name of an IT or business unit manager, a director or an executive who is most responsible for the solution and/or responsible for the ultimate realization of the project). Other information can be selected by the user from drop-down menus provided to the user by the project information template. For example, the main budgetary goal, which reflects how the results of a project will tally and contribute to the overall budget of an organization, can be selected from a drop-down list providing choices of: (1) IT cost reduction; (2) business operating efficiency; (3) Business Strategic advantage and (4) mandatory project. (Here the choice of IT cost reductions signifies reductions in overall operations budget, the choice of business operating efficiency signifies reducing cost of goods sold (COGS), sales, general and administrative (SG&A) expenses, research and development (R&D) expenses or interest expenses, while the choice of business strategic advantage signifies improving sales/revenue, etc.). Similarly the project start date can be selected from a drop-down menu that list the years beginning with the current year and extends up to a certain predetermined number of years. The project information template also includes a “notes” window that provides comments to a user regarding various values that the user is required to input into the project information template. While some of the information required by the project information template is mandatory other information is optional. For example, it would be mandatory to input a name for a project while starting a new project analysis, however, it is optional to input the project manager's name in the project information template. Using the project information template a user can also specify what is the overall IT strategic goal and initiative that the project ties to. The main strategic goal is used to align projects to overall goals of the organization.

The project information template also allows a user to provide parameters that can be accessed by other worksheets within a project using a project questionnaire. Such a project questionnaire allows a user to define a worksheet with a set of questions specific to the project being analyzed. For example, for a project involving windows server consolidation, such a questionnaire may be set up to ask a user various questions such as: how many servers are currently installed, what is the current expected growth in server count, what is the typical price per server, etc. Such project questionnaire can be created when a user has indicated to create a new project analysis at the beginning of the first software module 302. A project questionnaire is useful in that it can be sent to a person who is knowledgeable about answers to various questions listed in the project questionnaire in the form of a spreadsheet. Once such project questionnaire spreadsheet is populated by relevant information, the project questionnaire spreadsheet should be stored at a given location in the memory 104 of computer 100, so that the first software module 302 can access the data in the project questionnaire.

Finally, at block 410 the user is also required to input information about a preparer of the project analysis, such as the preparer's name, organization name, office address, phone number, e-mail address, etc. Similarly, in one implementation of the first software module 302, the user is also asked to input information regarding the organization for which the user is preparing the project analysis. For example, such information may include the organization's name, its address, its website address, contact name, e-mail address of the contact at such organization, etc. It should be noted that in an alternate implementation of the first software module 302, the project information template may ask a user to input a number of other information not listed above.

At block 412, the first software module 302 presents to the user an IT cost template from the input template database 208. Such an IT cost template collects information about various IT costs related to the project being analyzed. The IT costs related to projects are divided into three categories as follows: (1) capital purchases including purchase of software applications, operating systems, servers, PCs, wireless and portable devices, network components and peripherals; (2) fees including one time or on-going fees for services such as maintenance and support agreements, communication fees, professional/outsourced services and technical training and certification; and (3) labor costs including lifecycle management cost for personnel to perform planning, development, deployment, management, maintenance and refresh/disposal.

The IT cost template presented to the user at block 412 allows a user to add one or more new IT costs related to the project being analyzed, to change an existing IT cost related to the project being analyzed or to remove an existing IT cost related to the project being analyzed. For each IT cost being added by a user, the user is allowed to input various information such as a name of the IT cost being added, an IT budget category to which the IT cost maps to, a corporate financial category that the IT cost maps to, an initial cost at the start of the project, a cost of the project for year 1, 2 and 3, etc. Some of this information can be inputted by a user in any form, for example, a user can give any name to the IT project. However to input some other information a user may have to select an alternative value from a drop-down menu. For example, to map a cost to an IT budget category, a user can select from a number of choices including, but not limited to (1) data center servers, (2) the distributed processing, (3) purchased software, (4) purchased services, (5) communications, etc. The user should select an IT cost category that best matches the cost being added, or an IT cost category under which he wants the new IT cost to be sub-totaled. Similarly, to map an IT cost to a corporate financial category, a user can select from a number of choices including, but not limited to (1) general and administrative, (2) cost of goods sold, (3) sales and marketing, (4) research and development, (5) interest expense, etc.

The IT cost template presented to a user allows the user to input cost for the selected project either manually in the IT cost template or by using a worksheet that is used in conjunction with the IT cost templates. A user can select an IT cost to be inputted using a worksheet by selecting the worksheet icon from the IT cost template. Once the user selects to use a worksheet to input an IT cost, he can either select a worksheet from a number of worksheets in a library that is stored in the memory 104 of computer 100, or he can add a new worksheet to this library and define the structure of such worksheet. Using a worksheet to calculate the IT cost is advantageous because it allows a user to distribute such a worksheet to a person who is knowledgeable about various costs related to the project being analyzed and save such information at a given location in the memory 104 of computer 100 that can be accessed by the first software module 302. In an embodiment of the first software module 302 illustrated here, the IT cost template is designed to collect from the user IT costs for the first three years of any project being analyzed. However, in an alternate environment the IT cost template can be provided to collect the IT costs for an alternate number of years.

At block 414, the first software module 302 presents to a user a business unit cost template from the input template database 208. Such a business unit cost template collects information about various project costs related to the project being analyzed, that are borne by various business units. Business unit costs may include start-up costs or ongoing management costs. Business unit costs are typically divided into three major categories: (1) administrative costs are the investments by a business unit in helping to plan, develop, deploy, maintain and support a project; (2) user training costs are the investments made by a business unit in training users on the technology, or training business unit resources to help manage the technology; and (3) other costs are costs borne by the business unit in implementing the project, such as costs which have traditionally been IT related such as asset purchases, application development, deployment, maintenance and support.

The business unit cost template allows a user to map each of the business unit cost to an IT budget category using a drop-down menu. As mentioned above, such IT budget categories include (1) administrative, (2) user training and (3) other. Similarly, the business unit cost template also allows a user to map each of the business unit cost to a corporate finance category such as (1) general and administrative, (2) cost of goods sold, (3) sales and marketing, (4) research and development, (5) research and development, etc. In an embodiment of the first software module 302 illustrated here, a user can input the business unit cost for each of the first three years of the life of a project. However, in an alternate embodiment a business unit cost template can be provided so that a user can input business unit costs for an alternate number of years. The business unit cost template allows a user to input the business unit costs for each year either directly into the business unit cost template or by using a worksheet which can be saved in the memory 104 of the computer 100. A user can activate such a worksheet by clicking on the worksheet icon on the business unit cost template. Such a worksheet can be used to quantify each of the annual business unit costs. A user can select a worksheet from a library of worksheets where such a worksheet provides an essential starting point in creating a model used in calculating each of the annual business unit costs.

At block 416, the first software module 302 presents to a user an IT cost reductions template from the input template database 208. The IT cost reductions template collects information about tangible benefits accruing to the ongoing IT operating budget as well as specifies improvements to several key performance indicators (KPI) related to IT due to the project being analyzed.

Tangible benefits accruing to the ongoing IT operating budget typically include the following: (1) savings in planned capital purchases such as software applications, operating systems, servers, PCs, wireless and portable devices, network components and peripherals, etc.; (2) savings in ongoing fees such as support and maintenance contracts, communication fees, professional/outsourced services and technical training and certification, etc.; and (3) reductions in IT related labor costs such as lifecycle management cost for personnel to perform planning, development, deployment, management, support, maintenance and refresh/disposal.

By presenting an IT cost reductions—benefits template the IT cost reduction template allows a user to add or remove a tangible benefit accruing due to a project being analyzed. Using such an IT cost reductions—benefits template, a user can input information related to a tangible benefit such as name of such a tangible benefit, an IT budget category to which the tangible benefit maps, a corporate financial category to which the tangible benefit maps, values of the benefit for a number of years, etc. In the present embodiment of the first software module 302 the IT budget categories and the corporate financial categories to which the tangible benefit maps are the same as those provided in the business unit costs template. The IT cost reduction benefits template also allows a user to input a value of the tangible benefits for a number of years. A user can input such values directly into the IT cost reduction—benefits template or he can select to have such values inputted using a worksheet by clicking on a worksheet button provided on the IT cost reduction—benefits template.

The KPIs specify a particular measure indicating an improvement in IT, such as customer satisfaction rankings, responsiveness, innovation, etc. The IT cost reduction template allows the user to add or remove a KPI accruing due to a project being analyzed, by presenting an IT cost reductions—KPI template from the input template database 208. The IT cost reductions—KPI template allows the user to input information regarding a KPI attached to a project being analyzed such as name of the KPI, the unit of measure for the KPI (e.g., full time equivalents (FTE), person hours, calls, minutes, hours, tasks, ratios, etc.), base case or current measure of the KPI without the project being analyzed, and the expected annual KPIs for a given number of years with implementation of the project being analyzed.

At block 418, the first software module 302 presents to a user a business operating efficiency template from the input template database 208. Such a business operating efficiency template collects information about tangible savings and benefits to ongoing business operating costs and improvements in several key intangible business indicators or benefits, where such tangible and intangible benefits are attributed to a project being analyzed.

Tangible benefits to a business that are attributed to a project being analyzed may include savings to planned business unit capital expenditures, reductions in required user labor costs, contract fees, etc. Such tangible benefits may also include savings in operating budget for sales and marketing, savings in general and administrative expenses, savings in research and development, savings in interest expenses, savings in depreciations, etc. A user can add or remove a tangible saving to the business operating efficiency by selecting a business operating efficiency—savings template. The business operating efficiency—savings template allows a user to input various information related to a business operating efficiency saving such as a name of such a business operating efficiency saving, a mapping of such a saving to a corporate financial category, and values of such a saving for a given number of years. The values of the business operating efficiency savings can be inputted by a user either directly into the business operating efficiency savings template or by using a worksheet by clicking on the worksheet icon on the business operating efficiency—savings template. A business operating efficiency saving can be mapped to corporate financial categories such as (1) general and administrative, (2) cost of goods sold, (3) sales and marketing, (4) research and development, etc.

Intangible benefits to a business attributed to a project being analyzed may include various KPIs such as customer satisfaction rankings, business responsiveness, inventory turnover, etc. A user can input information regarding an intangible business operating efficiency benefit by selecting a business operating efficiency—KPI template from the input template database 208. A business operating efficiency—KPI template allows a user to input information related to an intangible business operating efficiency benefit such as name of the intangible business operating efficiency benefit, a unit of measure for the intangible business operating efficiency benefit such as FTE, person hours, calls, minutes, hours, tasks, ratios, etc., a base case or current measure of the KPI without the project being analyzed and the expected annual KPIs for a given number of years with the implementation of the project being analyzed.

At block 420, the first software module 302 presents to a user a business strategic advantage template from the input template database 302. The business strategic advantage template collects information about various tangible strategic benefits to an organization and improvements to several business strategic KPIs due to the project being analyzed. An example of a tangible strategic business benefit is an increase in gross revenues due to implementation of the project being analyzed. A strategic KPI may be a market position ranking in comparison to peers with respect to, for example, revenue per employee, etc. Any information inputted in this template should be developed with the cooperation of a corporate business unit executive or a manager responsible for the tangible strategic business initiative being considered.

Using a business strategic advantage benefits template, the user can input various information about tangible benefits such as a name of a tangible strategic benefit, values of the tangible benefit for a given number of years and a corporate financial category to which such tangible benefit gets mapped to. The corporate financial categories to which the tangible benefit gets mapped to may include (1) general and administrative, (2) cost of goods sold, (3) sales and marketing, (4) research and development, etc. A user can use a dropdown menu provided in the business strategic advantage benefits template to select one of such a corporate financial category to which the tangible benefit gets mapped to. A user can either provide the value of the tangible benefit directly into the business strategic advantage benefits template or the user can use a worksheet to quantify the annual values of the tangible benefit, where such spreadsheet can be saved in the memory 104 of the computer 100. A user can also select a worksheet from a library of worksheets where such a spreadsheet provides the user an essential starting point in creating a model used in calculating the value of the annual tangible benefit.

Using a business strategic advantage KPI template, a user can input various information about a business strategic KPI such as a name of the KPI, unit used to measure the KPI, a base case, which is a measure of the initial expected annual KPIs without the implementation of the project being analyzed and annual values of the KPI for a given number of years. The unit used to measure the KPI may be FTEs, person hours, calls, minutes, hours, tasks, ratios, etc.

At 424 the first software module 302 (1) tallies all of the financial information related to one or more IT projects being analyzed along with the financial information about an organization in which such IT projects are being implemented; (2) calculates a number of indices for the IT projects being analyzed and the organization for which such IT projects are being analyzed; and (3) presents one or more of these indices through a series of financial analysis templates stored in the report template database 206.

In the present embodiment of the first software module 302, a user can select one of the following financial analysis templates: (1) cost tables template; (2) cost graphs template; (3) costs pie chart template; (4) benefits table template; (5) benefits graph template; (6) benefits pie chart template; (7) ROI analysis table template; and (8) ROI analysis graph template. All of these templates are stored in the report template database 206.

When a user selects a costs table template to be displayed, the first software module 302 tallies total investments in an IT project being analyzed and presents IT costs, business unit costs and total costs for initial year as well as a given number of years during the life of the IT project. The costs table template also includes a what if factor for each of the years for which the costs are presented and adjusts the total costs for each year by such what if factors to present total adjusted costs for each year. What if factors allow a user to adjust total IT costs due to expected cost overruns. Default values of such what if factors are one hundred percent for each year, however, a user can change the values of such what if factors by selecting the what if factor template as specified below at block 430 of the first software module 302.

When a user selects a costs graph template to be displayed, the first software module 302 tallies total investments in an IT project being analyzed and presents IT costs, business unit costs and total costs for initial year as well as a given number of years during the life of the IT project in a bar chart format. The first software module 302 allows a user to make a copy of the bar chart in a bitmap (in a format such as GIF, JPG, etc.) by clicking on a copy button on the costs graph template and save the bitmap as a new file on the hard drive or disk drive of the computer 100.

Similarly, when a user selects a costs pie chart template to be displayed, the first software module 302 tallies total investments in an IT project being analyzed and presents IT costs, business unit costs and total costs for initial year as well as a given number of years during the life of the IT project in a pie chart format. The first software module 302 allows a user to make a copy of the pie chart in a bitmap (in a format such as GIF, JPG, etc.) by clicking on a copy button on the costs pie chart template and save the copy as a new file on the hard drive or disk drive of the computer 100.

When a user selects a benefits table template to be displayed, the first software module 302 tallies and presents total tangible benefits accruing due to an IT project being analyzed such as IT cost reductions, business operating efficiencies, business strategic advantages and total tangible benefits for the initial year as well as a given number of years during the life of the IT project. The benefit table template also includes a what if factor for each of the year for which the benefits are presented and adjusts the total benefits for each year by such what if factors to present total adjusted benefits for each year. What if factors allow a user to adjust total IT benefits due to expected increase in benefits.

When a user selects a benefits graph template to be displayed, the first software module 302 tallies total tangible benefits accruing due to an IT project being analyzed such as IT cost reductions, business operating efficiencies, business strategic advantages and total tangible benefits for the initial year as well as a given number of years during the life of the IT project and presents these benefits in a bar chart format. The first software module 302 allows a user to make a copy of the graph in a bitmap (in a format such as GIF, JPG, etc.) by clicking on a copy button on the benefits graph template and save the copy as a new file on the hard drive or disk drive of the computer 100.

Similarly, When a user selects a costs pie chart template to be displayed, the first software module 302 tallies total tangible benefits accruing dues to an IT project being analyzed such as IT cost reductions, business operating efficiencies, business strategic advantages and total tangible benefits for the initial year as well as a given number of years during the life of the IT project and presents these benefits in a pie chart format. The first software module 302 allows a user to make a copy of the pie chart in a bitmap (in a format such as GIF, JPG, etc.) by clicking on a copy button on the benefits pie chart template and save the copy as a new file on the hard drive or disk drive of the computer 100.

When a user selects an ROI analysis table template to be displayed, the first software module 302 calculates and displays a number of indices based on the total costs and total benefits related to an IT project being analyzed. For example, one of the indices displayed by the ROI analysis table template is net present value (NPV) of the savings accruing due to the IT project. Examples of other indices calculated and displayed are return on investment (ROI), internal rate of return (IRR), payback period, etc. Methods of calculating NPV, ROI, IRR and payback period are well known to those of ordinary skill in the art. The ROI analysis table template also displays a risk adjusted discount rate that is used to calculate some of the indices displayed on the ROI analysis table template. Similarly, when a user selects an ROI analysis graph template to be displayed, the first software module 302 calculates and displays a number of indices based on the total costs and total benefits related to an IT project being analyzed in a bar chart format.

At block 426, the first software module 302 presents to the user a risk assessment template from the input template database 208. The risk assessment template allows a user to define and estimate potential risks that can arise with the planning, deployment, adoption and use of an IT project being analyzed. The risk assessment template allows each of the possible risk defined by the user to be specified and scored as to the likelihood of its occurrence and its potential impact on the financial statement of an organization in which the IT project is to be implemented. For example, the user can define the likelihood of occurrence for a given project by selecting a percentage value from a drop down menu presented by the risk assessment template. In the present embodiment of the first software module 302, a user can select any one of the following level of likelihood of occurrence of a risk and a numeric level assigned to each of the likelihood: (1) Very likely to occur—10, (2) likely to occur—7.5, (3) somewhat likely to occur—5, (4) less likely to occur—2.5, and (5) not likely to occur—1. Similarly, a user can also select one of the various levels of potential impact from such a risk. In the present embodiment of the first software module 302, a user can select any one of the following levels of potential impact of a risk and a numeric level assigned to each of the potential impact: (1) Extremely high—10, (2) high—7.5, (3) medium—5, (4) low—2.5, and (5) extremely low—1. Any risk selected by a user and attached to an IT project being analyzed is used to adjust the discount rate used to discount the cash flows accruing from that IT project, where the factor used to adjust the discount rate is calculated by multiplying the likelihood of occurrence and the impact level. For example, if a risk is assigned a high(10) likelihood of occurrence and a medium(5) impact level, an adjustment factor of 50 is applied to the discount factor used in calculating various indices at block 424.

At block 428, the first software module 302 presents to a user an intangible benefit analysis template. When a user selects the intangible benefit analysis template, first software module 302 summarizes and presents the impact of the IT project being analyzed on KPIs of the organization in which the project is being implemented. The intangible benefit analysis template summarizes the KPIs of the organization in following three categories: (1) intangible benefits—IT, (2) intangible benefits—operating efficiency and (3) intangible benefits—strategic. For each of these categories, the intangible benefit analysis template presents the KPIs for the initial base year, which represents KPIs without the implementation of the IT project, and the KPIs for the subsequent years through the life of the IT project.

At block 430 the first software module 302 presents to a user an industry defaults template. Using the industry default template, a user can input certain key financial information used in calculation of the indices such as NPV, ROI, etc. For example, a user can define the cost of capital by selecting the cost of capital industry default template. A user can input the rate at which an organization implementing the IT project being analyzed can borrow money as the cost of capital. A user should consult the finance department of the organization to get such cost of capital. When calculating the NPV, the cost of capital is adjusted by the risk rates inputted using the risk assessment template at block 426. The industry defaults template also allows a user to input various what if scenario numbers that allows a user to test various cost overrun situations.

The section of benefit schedules in the industry defaults template allows a user to specify what percentage of the benefits that he specified earlier in blocks 416, 418 and 420 will be allocated to the IT project being analyzed while calculating various indices such as ROI, NPV, etc. A user can select a percentage between 0 and 100 percentages as the percentage of benefits allocated for each year of the life of an IT project being analyzed. Using this template a user can account for various time related characteristics of benefits accruing due to an IT project, such as, technology learning or adoption curve that will result in only part of the benefits realized in the earlier years in the life of an IT project, etc.

Similarly, the industry defaults template also allows a user to input various risk impact scalers where each of the risk impact scaler specifies a risk adjustment rate by which a discount rate is adjusted for a given range of risk assessments calculated in block 426 of the first software module 302. The present embodiment of the first software module 302 allows risk impact scalers to be specified for the following seven ranges of risk assessment: (1) 0% to 10%, (2) 11% to 20%, (3) 21% to 30%, (4) 31% to 40%, (5) 41% to 50%, (6) 51% to 60%, and (7) 61% to 70%.

FIG. 5 is a flowchart illustrating an example second software module 304 to compare IT spending of an organization with IT spending of other organizations where such other IT organizations are selected by a user. Although the second software module 304 is described here with reference to the flowchart illustrated in FIG. 5, a person of ordinary skill in the art will readily appreciate that many other methods of performing the acts associated with second software module 304 may be used. For example, the order of many of the blocks may be changed, and some of the blocks described may be removed without affecting the performance of the other blocks within the program. The second software module 304 may reside in either the memory 104 of the computer 100 illustrated in FIG. 1, or it may be stored on some other computer readable medium, such as a floppy disk, a compact disk, etc.

Referring to FIG. 5, at block 502, the second software module 304 presents an input template to a user asking whether the user wants to continue an existing peer analysis using information stored in the memory 104 or start a new peer analysis. If the user selects to create a new analysis, at block 504 the second software module 304 creates a new records in the organization information database 210 and the peer information database 212. However, if the user selects to continue an existing peer analysis, at block 506, the second software module 304 asks the user to name the existing peer analysis that the user wants to open and at block 508, the second software module 304 directs the input template to show the information from the records related to the peer analysis named by the user at block 508. Once the user selects whether he wants to work on a new peer analysis or to open an existing peer analysis, the second software module 304 presents a series of identical input templates from the input template database 208. The only difference between a template presented to the user when a user selects a new peer analysis versus when a user selects an existing peer analysis is that when a new peer analysis is selected, the subsequent input templates are not populated by any information, whereas when an existing peer analysis is selected the subsequent input templates are populated with data from an organization record in the organization information database 210 and/or with data from a peer record from a peer information database 212. When a new peer analysis is selected, a user can input data in any of the subsequent input templates. Similarly, if an existing peer analysis is selected, the user can input or change data in any of the subsequent input templates. Because the input templates appearing during the execution of the second software module 304 are the same for both a new peer analysis or for an existing peer analysis, the remainder of the second software module 304 is described with respect to new peer analysis only, and it should be understood that that same templates can also be used to change data for an existing peer analysis.

Referring to FIG. 5, at block 510, the second software module 304 presents to a user a company profile template from the input template database 208. Such company profile template allows a user to input key information about an organization for which a peer analysis is being prepared. Using the company profile template a user can input various information about an organization, the organization's financial statements, balance sheet, employee profile, and other information such as who is preparing this peer analysis as well as who is going to be using this peer analysis. Information about an organization may include the organization's name, the fiscal year for which the peer analysis for the organization is being prepared, a standard industrial classification (SIC) code of the organization, etc.

A user can input information about an organization's financial statements by selecting the financial statements section of the company profile template. Information about an organization's financial statements may include the organization's net revenues, cost of goods sold, SG&A costs, net profits, interest or cost of capital, return on equity, etc. The information about the organization's financial statements should be inputted from the organizations latest available financial statement. For the peer analysis, an appropriate business unit level should be selected, for example, if a peer analysis is to be conducted for a subsidiary, the financial statements of such a subsidiary should be used.

A user can input information about an organization's balance sheet by selecting the balance sheet section of the company profile template. Information about the organization's balance sheet may include the organization's assets, liabilities, etc. The information about the organization's balance sheet should be inputted from the organizations latest available balance sheet. For the peer analysis, an appropriate business unit level should be selected, for example, if a peer analysis is to be conducted for a subsidiary, the balance sheet of such a subsidiary should be used.

A user can input information about an organization's employee profile by selecting the employee profile section of the company profile template. Information about the organization's employee profile may include a number of information workers, a number of total IT staff, a number of non-information workers, etc. Such information can be obtained from human resource personnel of the organization. For the purpose of this program, an information worker is an employee who uses computers as part of their work, such as executive staff, knowledge workers, high performance worker, a data entry worker, etc. An IT staff is any of the IT executives and managers, IT administrators, IT developers and IT service desk workers. A non-information employee is one who does not use computer for his or her work, such as, assemblers, janitorial staff, etc. If a peer analysis is being considered for the entire organization, a user should enter appropriate numbers for the entire organization in the employee profile section of the company profile template, otherwise, only information about the unit of the organization for which the analysis is being considered should be entered.

Finally a user may input information about who is the preparer of the peer analysis report by selecting the prepared by section of the company profile. Similarly a user can input information about who is the user of the peer analysis report by selecting the prepared for section of the company profile template.

At block 510, the second software module 304 presents to a user a peer group selection template from the input template database 208. Such a peer group selection template allows a user to select a set of peer organizations to which an organization is being compared. A user can select a set of peer organizations using a number of criteria including, but not limited to, SIC code, number of employees, company revenues, primary geographic region, etc.

A user can select a set of peer organizations by SIC code by selecting a group by SIC section of the peer group selection template. When the group by SIC section is selected, the second software module 304 presents a template from the input template database 208 that includes a list of names of organizations and their SIC codes. The second software module 304 may obtain such a list of organizations with SIC codes by using the peer information database 212. A user can select one or more SIC codes by selecting the input box next to the names of various industry classifications listed on the group by SIC section of the peer group selection template.

Similarly, a user can select a set of peer organizations by other criteria such as number of employees, revenues and primary geographic location by selecting the group by selection criteria section of the peer group selection template. In the present embodiment of the second software module 304, the group by selection criteria section of the peer group selection template allows a user to define a peer group by number of employees in three different groups, namely, small organizations (0-5000 employees), medium organizations (3000-25000 employees) and large organizations (20000 or more employees). Similarly, the group by selection criteria section of the peer group selection template allows a user to define a peer group by revenues in three different groups, namely, small organizations (less than $10 M), medium organizations ($10 M-$1 B) and large organizations (greater than $1 B). Similarly, the group by selection criteria section of the peer group selection template allows a user to define a peer group by geographic in two different groups, namely, US and non-US organizations. As it will be clear to one of ordinary skill in the art, alternative embodiment of the second software module 304 may allow a user to select a set of peer organizations using a number of different criteria.

The second software module 304 uses the criteria provided by a user in each section of the peer group selection template to extract information about peer organizations from the peer information database 212. The peer information database 212 contains various financial and other information about various organizations. Such information may be obtained from financial statements of various organizations. In an alternate embodiment, the peer information database 212 may contain only identifiers for each of the various organizations which may be selected to be part of the peer group, and when a user selects such an organization to be included on a peer analysis report, the second software module 304 may download the current information about selected organizations from a public database provided by the securities and exchange commission (SEC) by using the organization identifier.

A user can view the list of organizations in the selected peer group by selecting the peer group results section of the peer group selection template. If such a list appears to be too long, a user may redefine the peer selection criteria. Ideally peer group selection criteria should be such that it results in six to ten companies in the peer group. Once a user has finalized a peer group to which he or she wants to compare the organization, he can compare various indices of the organization specified in block 510 to the corresponding indices for various organizations in the peer group by selecting the information productivity assessment template at block 514 or by selecting the IT spending assessment template at block 516.

At block 514, the second software module 304 calculates various indices for the organization selected at block 510 and for each of the organization from the set of organizations selected at block 512 and presents the comparisons in an information productivity assessment report template (hereinafter known as the CFO report). In this embodiment, the second software module 304 calculates EVA of an organization by the following formula:

EVA=Net Profit−Cost of Capital (Assets−Liabilities).

Once the EVA of an organization is calculated, the second software module 304 calculates the information productivity ratio of the organization by the following formula:

Information Productivity Ratio=EVA/(Information Management Expenditure).

A user can look at the values of various indices such as EVA, information management, information productivity, etc., for each of the various organizations from the peer group selected at block 512 and the organization selected at block 510 by selecting the information productivity ranking report in the CFO report template. A user can view the information productivity of various organizations in a bar chart form by selecting the information productivity graph report in the CFO report template. Another report in the CFO report template, named information productivity comparison report, allows a user to view the information productivity, revenues, profits and net assets of various organizations. Similarly, a financial metrics comparison report within the CFO report template allows a user to view another group of indices, namely, revenue per employee, EVA per employee and return on equity for various organizations. Finally, an SG&A comparison report within the CFO report template allows a user to view another group of indices including SG&A per COGS, SG&A per net assets, SG&A per revenue and SG&A per employee for various organizations.

At block 516, the second software module 304 presents the IT spending assessment template (hereinafter referred to as the CIO report). The CIO report template allows a user to input various IT expenditure related information for the organization selected at block 510. After receiving such information, the CIO report calculates various IT expenditure related indices for the organization selected at block 510 and for each of the set of organizations selected at block 512.

A user can input information about the IT expenditure of the organization selected at block 510 by selecting the IT spending profile template of the CIO report template. The IT spending profile template allows a user to input the following information about the organization selected at block 510: (1) official IT budget, (2) additional IT spending in business units, (3) business innovation as a percentage of total IT spending (i.e., official budget+additional business unit spending+indirect spending), (4) average annual hours spent on IT tasks (per user), (5) average unburdened user salary, and (6) burdened salary rate(%). Here the official IT budget is the current total budget for IT, including all capital, contracts, fees and labor expenses for IT headcount. The additional IT spending covers the IT spending that is under control of various business units, including business units capital spending on technology as well as expenses for business unit labor spent on IT tasks such as development and maintenance, administration and support. The average annual hours spent on IT tasks by non-IT user is an estimate of how much time an average user spends in supporting himself or herself and other users in lieu of any formal support from IT staff. This includes answering questions from peers, figuring out doing tasks, etc. The average user salary is specified as average annual unburdened salary. A burdened salary rate is provided to cover taxes, health benefits, vacation and sick days.

A user can overview the overall IT budget by selecting the IT spending overview template from the CIO report template. The IT spending overview template quantifies the overall IT budget as a sum of the official IT budget, additional IT spending in the business units, and indirect IT spending (in the form of self and peer support). The IT spending assessment template in the CIO report template shows the overall IT budget components (same as those shown in the IT spending overview) in a pie chart form. A user can make a bitmap image of the IT spending assessment pie chart by clicking the copy button on the IT spending assessment template.

The IT spending comparison template of the CIO report template shows the estimated IT spending of the organization selected at block 510 in comparison to the estimated IT spending for each of the organization from the set of organizations selected at block 512. This template also shows the ratio of IT spending as a percentage of revenue for the organization selected at block 510 in comparison to the estimated IT spending for each of the organization from the set of organizations selected at block 512.

The IT spending graph template of the CIO report template shows the estimated IT spending of the organization selected at block 510 in comparison to the estimated IT spending for each of the organization from the set of organizations selected at block 512 in a bar chart format. A user can make a bitmap image of the IT spending graph by clicking the copy button on the IT spending graph template. Similarly, the IT spending/revenue graph template shows the ratio of IT spending as a percentage of revenue for the organization selected at block 510 in comparison to the estimated IT spending for each of the organization from the set of organizations selected at block 512 in a bar graph format.

The workforce IT spending template of the CIO report template shows the IT spending estimates per employee and per information employee for the organization selected at block 510 in comparison to the IT spending estimates per employee and per information employee for each of the organization from the set of organizations selected at block 512.

The IT spending/employee graph template of the CIO report template shows the IT spending estimates per employee for the organization selected at block 510 in comparison to the IT spending estimates per employee for each of the organization from the set of organizations selected at block 512 in a bar chart format. Similarly, the IT spending/information worker graph template of the CIO report template shows the IT spending estimates per information employee for the organization selected at block 510 in comparison to the IT spending estimates per information employee for each of the organization from the set of organizations selected at block 512 in a bar chart format.

The IT innovation template of the CIO report template shows the overall IT budget and the IT spending on innovation such as new business applications for the organization selected at block 510. The IT innovation graph template of the CIO report template shows the overall IT budget and the IT spending on innovation such as new business applications for the organization selected at block 510 in a pie chart format.

The IT budget allocation template of the CIO report template allows a user to allocate the total IT budget for the organization selected at block 510 to various projects. In the present embodiment of the second software module 304, the IT budget allocation template allows the user to allocate the total IT budget to following projects: (1) data center and servers; (2) distributed processing; (3) purchased software; (4) purchased services; (5) communication; (6) development; (7) maintenance; (8) operation; and (9) overhead, supplies and other. The list of projects to which a user can allocate the total IT budget is dependent on the SIC code for the organization as selected at block 510. The second software module 304 ensures that the total of the percentages allocated to each of the projects as listed above is one hundred percentage, and if a user allocates a total which is higher or lower than one hundred percentage, the program reminds the user to change at least one of the allocations here so that the total is one hundred percentage.

The IT budget comparison template of the CIO report template presents the table with IT budget on various projects within the organization selected at block 510 in comparison to a benchmark low and a benchmark high value of IT spending on those projects, where such benchmark low and benchmark high are calculated based on the IT spending on such projects in the organizations from the set of peer organizations selected at block 512. The IT budget graph template of the CIO report shows the IT budget allocations to various projects for the organization selected at block 510 in a bar chart format.

FIG. 6 is a flowchart illustrating an example third software module 306 to allow a user to budget IT spending for an organization. Although the third software module 306 is described with reference to the flowchart illustrated in FIG. 6, a person of ordinary skill in the art will readily appreciate that many other methods of performing the acts associated with third software module 306 may be used. For example, the order of many of the blocks may be changed, and some of the blocks described may be removed without affecting the performance of the other blocks within the program. The third software module 306 may reside in either the memory 104 of the computer 100 illustrated in FIG. 1 or it may be stored on some other computer readable medium, such as a floppy disk, a compact disk, etc.

Referring to FIG. 6, at block 602, the third software module 306 presents an input template to a user asking whether the user wants to continue an existing budget analysis using information stored in the memory 104 or start a new budget analysis. If the user selects to create a new budget analysis, at block 604 the third software module 306 creates a new records in the organization information database 210 and the project information database 214. However, if the user selects to continue an existing budget analysis, at block 606, the third software module 306 asks the user to name the existing budget analysis that the user wants to open and at block 608, the third software module 306 directs the input templates to show the information from the records related to the budget analysis named by the user at block 608. Once the user selects whether he wants to work on a new budget analysis or to open an existing budget analysis, the third software module 306 presents a series of identical input templates from the input template module. The only difference between the templates presented to the user when the user selects a new budget analysis versus when a user selects an existing budget analysis is that when a new budget analysis is selected, the subsequent input templates are not populated by any information, whereas when an existing budget analysis is selected the subsequent input templates are populated with data from an organization record in the organization information database 210 or with data from a various project records from the project information database 214. When a new budget analysis is selected, the user can input data in any of the subsequent templates. Similarly, if an existing budget analysis is selected, the user can input or change data in any of the subsequent templates. Because the input templates appearing during the execution of the third software module 306 are the same for both a new budget analysis or for an existing budget analysis, the remainder of the third software module 306 is described with respect to new budget analysis only, and it should be understood that that same templates can also be used to change data for an existing budget analysis.

Referring to FIG. 6, at block 610, the third software module 306 presents to a user a report profile template from the input template database 208. The report profile template asks a user to select one or more projects to include in a budget analysis report and to specify a set of base case financials. A user can name the budget analysis report by selecting the report information template from the report profile template. The report information template allows the user to input a name for the budget analysis report and to select a starting year for the budget analysis report. After naming the budget analysis report, the user can select a list of projects which he or she wants to include in the budget analysis report by selecting a project selection template of the report profile template. The project selection template provides a method of selecting one or more projects from the project information database 214. A user can start creating a new list of projects to be included in the budget analysis report by selecting a project selection list template, which provides a list of projects from which a user can select one or more projects to be included in the budget analysis report. The project selection list template allows the user to select projects other than those listed currently in that template by selecting an import folder from the project information database 214. After selecting the import folder the user can import a number of projects from the import folder by clicking on the import projects tab on the project selection list, which will result in listing of all the projects from the selected import folder to be listed on the project selection list template, and subsequently the user can include them in the budget analysis report.

Once the user has selected a list of projects to be included in the budget analysis report, the user can input base case financial information about an organization whose IT budget is being analyzed. Such base case financial information should be the financial information about the organization before any of the projects being included in the budget analysis report are implemented. Such base case financial information should be prepared with help from finance personnel in the organization or from the latest financial statements of the organization. In the present embodiment of the third software module 306, the report profile template allows a user to input following information about the base case financial of an organization: (1) sales; (2) costs of goods sold; (3) sales and marketing; (4) general and administrative; (5) research and development; (6) interest expense; (7) depreciation; (8) cost of capital; (9) total assets; (10) total liabilities; and (11) IT operating budget. In the present embodiment, the report profile template allows a user to input each of the above information for a total of three years including the current year and two future years.

Once a user has input information about a base case financials of an organization and selected a list of projects to be included in the budget analysis report, at block 612 the user can view a number of budget analysis reports by selecting a budget analysis template. Using the budget analysis template, the third software module 306 summarizes information about the list of projects selected by the user and the base case financial information. The budget analysis templates presents various impact assessment reports to show how the financials of an organization will change as a result of implementation of projects selected in the list of projects. The third software module 306 applies summary of various costs and benefits accruing due to each of the projects from the list of projects to the base case financials of the organization.

Using an income statement base case table template of the budget analysis template, a user can view the base case income statements of the organization as it will be before any of the projects from the list of projects is implemented. An income statement proposed plan template of the budget planning template presents a table representing the impact of the implementation of the projects from the list of projects on the income statement of the organization. Another template named base case versus plan table template provides the comparison of the base case income statement versus the impact on the income statement due to implementation of the projects selected in the list of projects, as well as the difference between the base case income statement and the proposed income statement including the impact of such projects.

An investment impact table template presents the impact of the proposed projects on IT cost reductions, business operating efficiencies and business strategic advantages per each section of the income statement of the organization. Using the investment impact table template a user can find out, for example, what is going to be the impact of IT cost reductions on the general and administrative expenses due to implementation of the proposed projects. For another example, a user can find out how the business strategic advantages accruing due to implementation of the proposed projects will impact the sales of the organization. A financial impact table template presents impact of the proposed projects on IT cost reductions, business operating efficiencies and business strategic advantages per each section of the income statement of the organization in percentages.

Another template named IT budget plan table template in the budget analysis template allows a user to view the aggregate impact of all the projects, categorized by the type of the projects. Such categories may be, for example, IT cost reduction projects, business operating efficiency project, business strategic advantage project, mandatory project, etc.

The next template in the budget analysis template named the IT budget impact table allows a user to view the total IT budget spending broken down by various detailed IT spending categories. In the present embodiment of the third software module 306, the IT budget impact table template allows a user to view the total IT budget spending broken down by the following categories: (1) data center and servers; (2) distributed processing; (3) purchased software; (4) purchased services; (5) communication; (6) development; (7) maintenance; (8) operation; and (9) overhead, supplies and other.

The third software module 306 calculates the information productivities of the organization for the base case without the implementation of proposed IT projects, and the information productivities for the case in which the proposed projects are implemented, by dividing the EVA as defined above for each of the cases by the information investment for the corresponding case. A user can view such information productivities by selecting an information productivity impact table template. The information productivity impact table template presents the information productivities for a number of years in the base case, with the IT projects implemented and the difference between the two.

At block 614 the third software module 306 calculates a number of financial indices for each of the proposed projects selected at block 610. In the present embodiment, the third software module 306 calculates ROI, NPV, IRR and payback period for each of the selected projects. By selecting the IT cost reduction projects ROI table template, a user can view these indices for each of the projects that contributed to IT cost reductions. By selecting the business operating efficiency projects ROI table template, a user can view these indices for each of the projects that contributed to business operating efficiency. By selecting the business strategic advantage projects ROI table template, a user can view these indices for each of the projects that contributed to business strategic advantage. By selecting the mandatory projects ROI table template, a user can view these indices for each of the mandatory projects.

At block 616, the third software module 306 calculates a number of key performance indicators for each of the project from the list of projects selected at block 610. By selecting the IT cost reduction projects KPI table template, a user can view these KPIs for each of the projects that contributed to IT cost reductions. Similarly, by selecting the business operating efficiency projects KPI table template, a user can view the KPIs for each of the projects that contributed to business operating efficiency. Similarly, by selecting the business strategic advantage projects KPI table template, a user can view the KPIs for each of the projects that contributed to business strategic advantage. Whereas, by selecting the mandatory projects KPI table template, a user can view these KPIs for each of the mandatory projects.

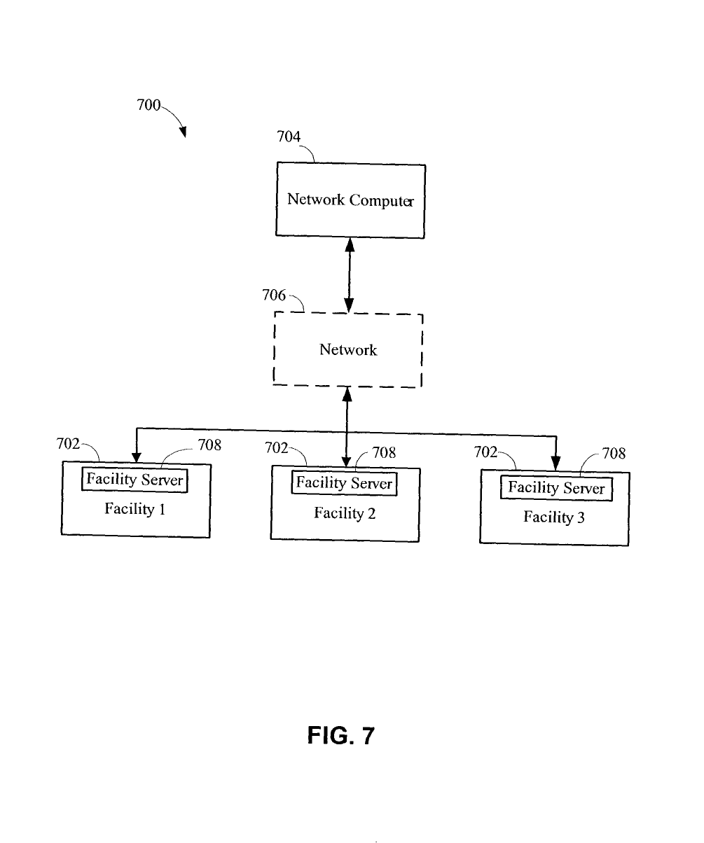

FIG. 7 illustrates a data network 700 including a first group of computing facilities 702 adapted to implement the apparatus 200 to evaluate an IT project. Specifically, FIG. 7 illustrates an embodiment of a data network 700 including a first group of computing facilities 702 operatively coupled to a network computer 704 via a network 706. The plurality of computing facilities 702 may be located, by way of example rather than limitation, in separate geographic locations from each other, in different areas of the same city, or in different states. The network 706 may be provided using a wide variety of techniques well known to those skilled in the art for the transfer of electronic data. For example, the network 706 may comprise dedicated access lines, plain ordinary telephone lines, satellite links, combinations of these, etc. Additionally, the network 706 may include a plurality of network computers or server computers (not shown), each of which may be operatively interconnected in a known manner. Where the network 706 comprises the Internet, data communication may take place over the network 706 via an Internet communication protocol.

The network computer 704 may be a server computer of the type commonly employed in networking solutions. The network computer 704 may be used to accumulate, analyze, and download data provided by each of the computing facilities 702. For example, the network computer 704 may periodically receive data from each of the computing facilities 702 indicative of information pertaining to an IT project's characteristics, information pertaining to financial characteristics of an organization, etc. The computing facilities 702 may include one or more facility servers 708 that may be utilized to store information for a plurality of IT projects, organizations, etc., associated with each facility.

Although the data network 700 is shown to include one network computer 704 and three computing facilities 702, it should be understood that different numbers of computers and computing facilities may be utilized. For example, the network 706 may include a plurality of network computers 704 and dozens of computing facilities 702, all of which may be interconnected via the network 706. According to the disclosed example, this configuration may provide several advantages, such as, for example, enabling near real time uploads and downloads of information as well as periodic uploads and downloads of information. This provides for a primary backup of all the information generated in the process of updating and accumulating data related to a number of IT projects and/or organizations.

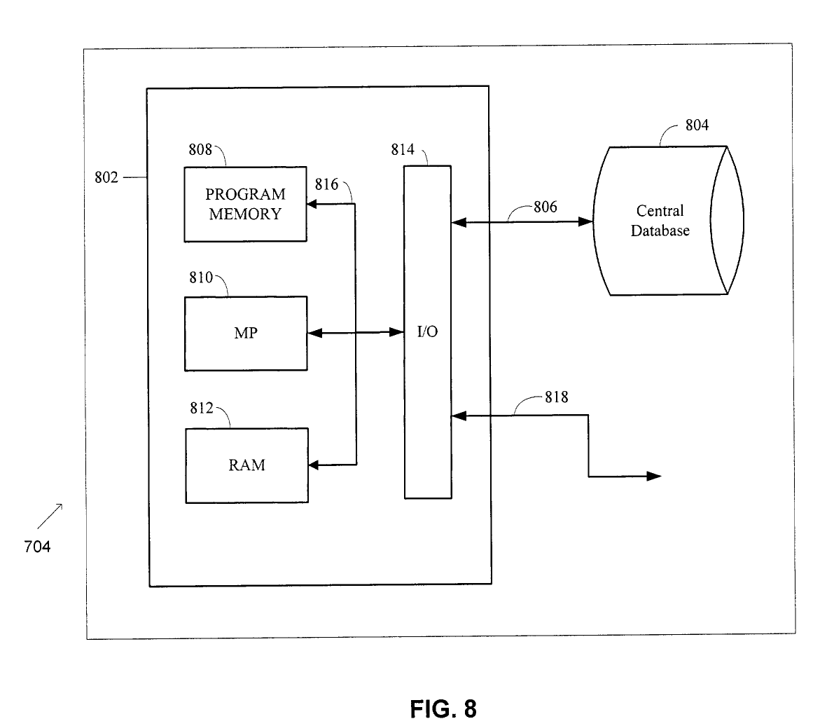

FIG. 8 is a schematic diagram of one possible embodiment of the network computer 704 shown in FIG. 7. The network computer 704 may have a controller 802 that is operatively connected to a central database 804 via a link 806. It should be noted that, while not shown, additional databases may be linked to the controller 802 in a known manner.

The controller 802 may include a program memory 808, a microcontroller or a microprocessor (MP) 810, a random-access memory (RAM) 812, and an input/output (I/O) circuit 814, all of which may be interconnected via an address/data bus 816. It should be appreciated that although only one microprocessor 810 is shown, the controller 802 may include multiple microprocessors 810. Similarly, the memory of the controller 802 may include multiple RAMs 812 and multiple program memories 808. Although the I/O circuit 814 is shown as a single block, it should be appreciated that the I/O circuit 814 may include a number of different types of I/O circuits. The RAM(s) 812 and programs memories 808 may be implemented as semiconductor memories, magnetically readable memories, and/or optically readable memories, for example. The controller 802 may also be operatively connected to the network 706 via a link 818.

In an alternate embodiment of the apparatus 200, the evaluation software module 202 may be implemented in program memory 808 and adapted to operate on microprocessor 810. In yet another embodiment of the apparatus 200, the database module 204 may be implemented in part or fully on the RAM 812 of the network computer 704. In yet another embodiment of the apparatus 200, at least some of the database module 204 may be implemented on the central database 804.

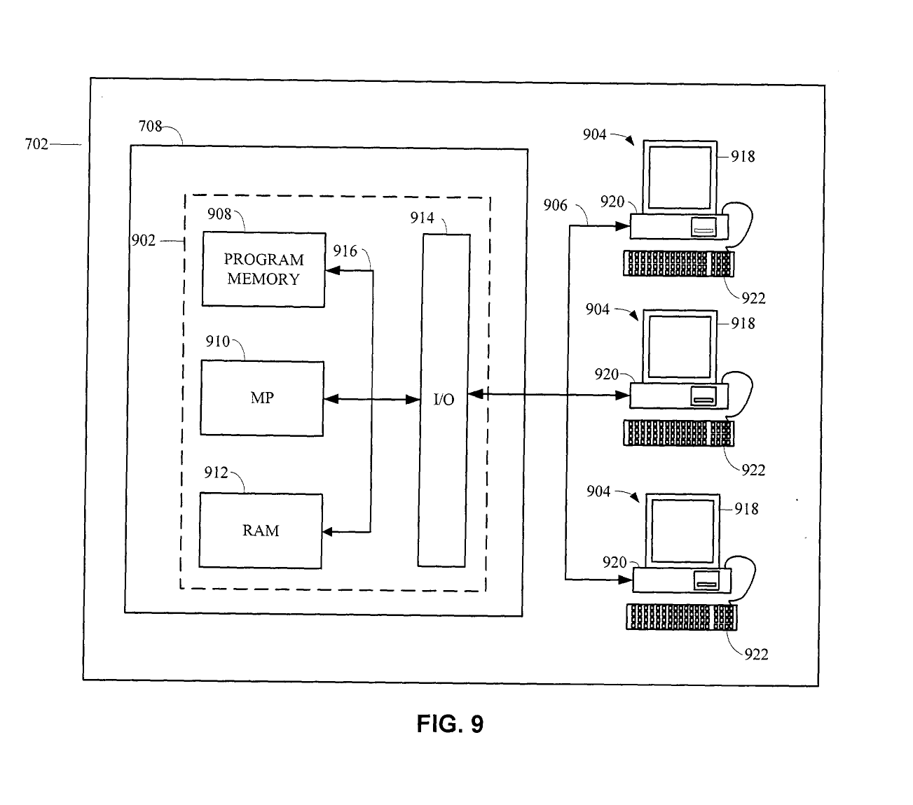

FIG. 9 is a schematic diagram of one possible embodiment of several components located in one or more of the computing facilities 702 from FIG. 7. Although the following description addresses the design of the computing facilities 702, it should be understood that the design of one or more of the computing facilities 702 may be different than the design of other computing facilities 702. Also, each computing facility 702 may have various different structures and methods of operation. It should also be understood that the embodiment shown in FIG. 9 illustrates some of the components and data connections present in a computing facility, however it does not illustrate all of the data connections present in a typical computing facility. For exemplary purposes, one design of a computing facility 702 is described below, but it should be understood that numerous other designs may be utilized.

The computing facilities 702 may have a facility server 708, which includes a controller 902, wherein the facility server 708 is operatively connected to a plurality of client device terminals 904 via a network 906. The network 906 may be a wide area network (WAN), a local area network (LAN), or any other type of network readily known to those persons skilled in the art. The client device terminals 904 may also be operatively connected to the network computer 704 from FIG. 7 via the network 706.

Similar to the controller 802 from FIG. 8, the controller 902 may include a program memory 908, a microcontroller or a microprocessor (MP) 910, a random-access memory (RAM) 912, and an input/output (I/O) circuit 914, all of which may be interconnected via an address/data bus 916. As discussed with reference to the controller 902, it should be appreciated that although only one microprocessor 910 is shown, the controller 902 may include multiple microprocessors 910. Similarly, the memory of the controller 902 may include multiple RAMs 912 and multiple programs memories 908. Although the I/O circuit 914 is shown as a single block, the I/O circuit 914 may include a number of different types of I/O circuits. The RAM(s) 912 and programs memories 908 may also be implemented as semiconductor memories, magnetically readable memories, and/or optically readable memories, for example.

The client device terminals 904 may include a display 918, a controller 920, a keyboard 922 as well as a variety of other input/output devices (not shown) such as a printer, mouse, touch screen, track pad, track ball, isopoint, voice recognition system, etc. Each client device terminal 904 may be signed onto and occupied by a computing employee to assist them in performing their duties. Computing employees may sign onto a client device terminal 904 using any generically available technique, such as entering a user name and password. If a computing employee is required to sign onto a client device terminal 904, this information may be passed via the link 906 to the facility server 708, so that the controller 902 will be able to identify which computing employees are signed onto the system and which client device terminals 82 the employees are signed onto.

Typically, facility servers 708 store a plurality of files, programs, and other data for use by the client device terminals 904 and the network computer 704. One facility server 708 may handle requests for data from a large number of client device terminals 904. Accordingly, each facility server 708 may typically comprise a high end computer with a large storage capacity, one or more fast microprocessors, and one or more high speed network connections. Conversely, relative to a typical facility server 708, each client device terminal 904 may typically include less storage capacity, a single microprocessor, and a single network connection.

An alternate embodiment of the apparatus 200 may be implemented on one or more of the computing facilities 702. For example, in one embodiment of apparatus 200, the evaluation software module 202 may be stored in the program memory 908. In yet another embodiment of the apparatus 200, the database module 204 may be implemented in part or fully on the RAM(s) 912 of the computing facilities 702, and one or more of the input templates from the input template database 208 and one or more of the report templates from the report template database 206 may be presented to a user on one or more of the client device terminals 904.

In the foregoing specification the present patent has been described with reference to specific embodiments. However, one of ordinary skill in the art will appreciate that various modifications and changes can be made to these embodiments without departing from the scope of the present patent as set forth in the claims below. Accordingly, the specification and figures are to be regarded in an illustrative rather than in a restrictive sense, and all such modifications are intended to be included within the scope of the present patent.

What is claimed is:

1. A method of evaluating a first IT project within an organization comprising the steps of:
receiving a first set of data representative of financial information about the organization and future assumptions about the organization;
receiving a second set of data representative of characteristics of the first IT project; and
generating a first set of indices based at least in part on the first and the second set of data.

2. A method as defined in claim 1 wherein the characteristics of the first IT project include at least one of costs of the first IT project, investments required by the first IT project, savings generated by the first IT project and strategic benefits generated by the first IT project.

3. A method as defined in claim 2 wherein the strategic benefits generated by the first IT project includes a number of intangible benefits.

4. A method defined in claim 2 further including:
displaying to the user a list of strategic benefits; and
receiving an input from the user selecting a first strategic benefit; and
associating the first strategic benefit to the first IT project.

5. A method as defined in claim 1 wherein the first set of indices includes at least one of return on investment (ROI), net present value (NPV), internal rate of return (IRR), economic value added (EVA) and payback period of the first IT project.

6. A method as defined in claim 1 wherein the step of receiving the second set of data comprises:
displaying to a user a first list of types of IT projects;
receiving an input from the user selecting a first type of IT project;
assigning the first type of IT project as a type of the first IT project;
displaying to the user a first set of characteristics dependent on the type of the first IT project; and
receiving a number of inputs from the user representing values of at least some of the characteristics of the first set of characteristics.

7. A method as defined in claim 6 wherein the first set of characteristics includes a risk associated with the first IT project.

8. A method as defined in claim 7 where the first set of indices is adjusted based on a value of the risk associated with the first IT project.

9. A method as defined in claim 1 further comprising estimating an impact of the first IT project on a future financial statement of the organization.

10. A method as defined in claim 1 further comprising estimating an impact of the first IT project on a strategic goal of the organization.

11. A method as defined in claim 1 further comprising estimating an impact of the first IT project on a key performance indicator of the organization.

12. A method as defined in claim 1 further comprising:
receiving a third set of data representative of characteristics of a second IT project;
displaying to a user a first list of IT projects;
receiving an input from the user selecting the first and the second IT projects;
combining the data representative of a first characteristic of the first IT project with the data representative of the first characteristic of the second IT project to get a first sum; and
automatically generating a second set of indices based at least in part on the first sum and the first set of data.

13. A method as defined in claim 1 further comprising:
receiving a third set of data representative of characteristics of a second IT project;
displaying to a user a list of IT projects;
receiving an input from the user selecting the first and the second IT projects;
calculating a second set of indices based at least in part on the first and the second set of data;
calculating a third set of indices based at least in part on the first and the third set of data; and
comparing at least some of the indices of the second set of indices with corresponding indices from the third set of indices.

14. A method as defined in claim 1 further comprising:
storing a first set of values of the first set of indices generated at a first point in time before the first IT project is implemented;
calculating a second set of values of the first set of indices at a second point in time after the first IT project is implemented; and
comparing the first set of values to the second set of values.

15. A method as defined in claim 1 further comprising:
providing a first set of assumptions regarding a future state of business conditions; providing a second set of assumptions regarding the future state of business conditions;
generating a second set of indices based at least in part on the first set of data, the second set of data and the first set of assumptions;
generating a third set of indices based at least in part on the first set of data, the second set of data and the second set of assumptions; and
comparing at least some of the second set of indices with the corresponding indices from the third set of indices.

16. A method as defined in claim 1, wherein the step of receiving the second set of data comprises:
displaying to a user a first list of the characteristics of the first IT project;
receiving a number of inputs from the user representing values of at least some of the characteristics of the first IT project;
transmitting the values of at least some of the characteristics of the first IT project over a communication network;
receiving the values of at least some of the characteristics of the first IT project; and
storing the values of at least some of the characteristics of the first IT project.

17. A method as defined in claim 16 further comprising:
transmitting at least some of the first set of indices over the communication network;
receiving at least some of the first set of indices; and
displaying at least some of the first set of indices on a user.

18. A method as defined in claim 1 wherein the step of receiving the first set of data comprises of obtaining a public file from a public datasource, containing at least some of the first set of data.

19. A method as defined in claim 1 wherein the step of receiving the first set of data comprises of automatically reading a worksheet specified by the user.

20. A method of evaluating a first IT project within a first organization comprising the steps of:
receiving a first set of data representative of financial information about the first organization and future assumptions about the first organization;
receiving a second set of data representative of characteristics of the first IT project;
providing a third set of data representative of past financial information and past IT expenditure of a first group of organizations;
generating a first set of indices based at least in part on the first and the second set of data;
calculating a second set of indices based at least in part on the third set of data; and
comparing at least one member of the first set of indices with a corresponding member of the second set of indices.

21. A method as defined in claim 21 wherein the first set of indices and the second set of indices includes at least one of (1) IT expenditure per revenue, (2) IT expenditure per assets, (3) IT expenditure per employee, and (4) IT expenditure per information employee.

22. A method as defined in claim 21 further comprising:
displaying a first list of characteristics representative of characteristics of business organizations;
receiving a number of inputs from a user representing a first range of values of at least some of the characteristics of the first list of characteristics;
selecting a second group of organizations from the first group of organizations for which the values of the characteristics of the first group of characteristics are within the first range of values;
selecting a fourth set of data representative of past financial information and past IT expenditure of the second group of organizations;
calculating a third set of indices based at least in part on the fourth set of data; and
comparing some of the first set of indices with the corresponding third set of indices.

23. A method as defined in claim 22 wherein the first list of characteristics includes at least one of SIC code, revenue, number of employees, and primary geographic location.

24. A method as defined in claim 23 wherein the first and the third set of indices includes at least one of economic value added (EVA), information productivity, revenue per employee, EVA per employee and return on equity (ROE).

25. A method as defined in claim 23 wherein the first and the third set of indices includes at least one of IT spending per revenue, IT spending per employee, IT spending per information employee and innovation budget.

26. A method as defined in claim 23 further comprising displaying the first and the third set of indices at least in the form of a pie chart or a bar chart.

27. A method as defined in claim 20, further comprising calculating an estimated IT budget of the first organization based on the first set of data and the third set of data and calculating an actual IT budget of the first organization from the second set of data.

28. A method as defined in claim 27, further comprising comparing the estimated IT budget of the first organization with the actual IT budget of the first organization.

29. A method as defined in claim 28, further comprising displaying the actual IT budget of the first organization as a percentage of the estimated IT budget of the first organization.

30. A project evaluation system for evaluating a first IT project within a first organization, the system comprising:
a computer processor communicating with a data entry device, wherein the data entry device is configured to receive a first set of data representative of revenues, expenses, investments and strategic goals of the first organization, and a second set of data representative of costs, savings, strategic benefits and risks related to the first IT project;
a memory;
a processing unit; and
a first software routine stored in the memory and adapted to be executed on the processing unit for calculating a first set of indices based at least in part on the first and the second set of data.

31. A project evaluation system of claim 30 further comprising a second software routine stored in the memory and adapted to be executed on the processing unit for calculating a second set of indices based on the first set of data and comparing at least one member of the first set of indices with a corresponding member of the second set of indices.

32. A project evaluation system of claim 30 wherein the data entry device comprises of a third software routine stored in the memory and adapted to be executed on the processing unit to display to a user a first list of types of IT projects, to receive an input from the user selecting a first type of IT project; to assign the first type of IT project as a type of the first IT project, to display to the user a first set of characteristics dependent on the type of the first IT project, and to receive a number of inputs from the user representing values of at least some of the characteristics of the first set of characteristics.

33. A project evaluation system of claim 30 wherein the first set of indices includes at least one of return on investment (ROI), net present value (NPV), internal rate of return (IRR), economic value added (EVA) and payback period.

34. A computer program stored on a tangible medium to evaluate a first IT project within a first organization, the computer program comprising:
first software to receive a first set of data representative of financial information about the first organization and future assumptions about the first organization;
second software to receive a second set of data representative of characteristics of the first IT project; and
third software to generate a first set of indices based at least in part on the first and the second set of data.

35. A computer program defined in claim 34 further comprising:
fourth software to display the first set of indices in a bar chart form; and
fifth software to display the first set of indices in a pie chart form.

36. A project evaluation system for evaluating a first IT project within a first organization, the system comprising:
a computer processor communicating with a memory, wherein the memory contains a first set of data representative of the revenues, expenses, investments and strategic goals of the first organization, and a second set of data representative of the costs, savings, strategic benefits and risks related to the IT project;
a processing unit; and
a first software routine stored in the memory and adapted to be executed on the processing unit to calculate the functions of;
calculating a first set of indices based on the first set of data,
calculating a second set of indices based on the second set of data, and
comparing at least one member of the first set of indices with a corresponding member of the second set of indices.

37. A peer evaluation system for estimating IT budget within a first organization, the system comprising:
a computer processor communicating with a memory, wherein the memory contains a first set of data representative of revenues, expenses, investments and strategic goals of the first organization, and a second set of data representative of financial information and IT expenditure of a number of organizations other than the first organization;
a processing unit; and
a first software routine stored in the memory and adapted to be executed on the processing unit to calculate a first set of indices based at least in part on the first and the second set of data.

38. A system as defined in claim 37 wherein the first set of indices includes at least one of (1) IT expenditure per revenue, (2) IT expenditure per assets, (3) IT expenditure per employee, and (4) IT expenditure per information employee.

39. A project evaluation system for evaluating a first IT project within a first organization, the system comprising:
first software to display a first list of characteristics of the first IT project and a second list of characteristic of the first organization to a user;
second software to receive a first set of data from the user representing values of at least some of the characteristics of the first IT project and a second set of data from a user representing values of at least some of the characteristics of the first organization;
third software for transmitting the first and the second set of data over a communication network;
fourth software to receive the first and the second set of data; and
fifth software to calculate a first set of indices based at least in part on the first and the second set of data.

40. A system for analyzing a first IT project within a first organization, the system comprising:
means for receiving a first set of data representative of financial information about the first organization and future assumptions about the organization;
means for receiving a second set of data representative of characteristics of the first IT project; and
means for generating a first set of indices based at least in part on the first and the second set of data.

41. A system of claim 40, wherein the means for receiving the second set of data includes:
means for displaying to a user a first list of IT projects;
means for receiving an input from the user selecting the first IT project;
means for displaying to the user a first set of characteristics dependent on a type of the first IT project; and
means for receiving a number of inputs from the user representing values of at least some of the characteristics of the first set of characteristics.

42. A system for evaluating a first IT project within a first organization, the system comprising:
means for receiving a first set of data representative of financial information about the organization and future assumptions about the organization;
means for receiving a second set of data representative of characteristics of the first IT project;
means for providing a third set of data representative of past financial information and past IT expenditure of a number of organizations other than the first organization;
means for generating a first set of indices based at least in part on the first and the second set of data;
means for calculating a second set of indices based at least in part on the third set of data; and
means for comparing at least one member of the first set of indices with a corresponding member of the second set of indices.
